(19) United States
(12) Patent Application Publication
(10) Pub. No.: US 2014/0324541 A1
(43) Pub. Date: Oct. 30, 2014

(54) USING REAL-TIME ONLINE ANALYTICS TO AUTOMATICALLY GENERATE AN APPROPRIATE MEASUREMENT SCALE

(71) Applicant: INTERNATIONAL BUSINESS MACHINES CORPORATION, Armonk, NY (US)

(72) Inventors: Nadeem Malik, Austin, TX (US); Rajesh Radhakrishnan, Reston, VA (US); Mithkal M. Smadi, Round Rock, TX (US)

(73) Assignee: International Business Machines Corporation, Armonk, NY (US)

(21) Appl. No.: 13/873,738

(22) Filed: Apr. 30, 2013

(51) Int. Cl. G06Q 30/02

(52) U.S. Cl. CPC G06Q 30/0203
USPC 705/7.32

(57) ABSTRACT

A method and associated systems for using real-time online text analytics and real-time online semantic analytics to automatically generate an appropriate measurement scale for a questionnaire, survey, interview, or other information-gathering instrument. The method uses known techniques, procedures, and models of real-time online analytics to infer meaning from a subject's unstructured response to a questioner's solicitation of information. It next uses these results to select one or more measurement scales from a repository of measurement scales and to customize those selected scales into forms appropriate to the researcher's solicitation. The processor then delivers the customized scale or scales to the researcher quickly enough to allow the researcher to use the delivered scales to immediately quantize or otherwise characterize the unstructured response.

### TECHNICAL FIELD

The present invention relates to automatically generating appropriate measurement scales in real time for questionnaires, surveys, interviews, and other information-gathering instruments.

### BACKGROUND

Appropriate measurement scales can improve the accuracy, accessibility, and usefulness of information gathered from a questionnaire, survey, interview, or other information-gathering instrument. But determining which scale is most appropriate for a particular question in such an instrument can be a time-consuming process that must often be performed by an experienced researcher or instrument designer.

### BRIEF SUMMARY

A first embodiment of the present invention provides a method for using real-time online analytics to automatically generate an appropriate measurement scale, the method comprising:

a processor of a computer system identifying a repository of measurement scales;

the processor receiving unstructured data from a user;

the processor performing an analytics procedure upon the unstructured data, wherein the performing produces an analytics result from which may be inferred an intended meaning of the unstructured data;

the processor selecting a selected measurement scale from the repository of measurement scales;

the processor generating a generated measurement scale as a function of the analytics result, wherein the generated measurement scale is associated with the selected measurement scale.

A second embodiment of the present invention provides a computer program product, comprising a computer-readable hardware storage device having a computer-readable program code stored therein, said program code configured to be executed by a processor of a computer system to implement a method for using real-time online analytics to automatically generate an appropriate measurement scale, the method comprising:

the processor identifying a repository of measurement scales;

the processor receiving unstructured data from a user;

the processor performing an analytics procedure upon the unstructured data, wherein the performing produces an analytics result from which may be inferred an intended meaning of the unstructured data;

the processor selecting a selected measurement scale from the repository of measurement scales;

the processor generating a generated measurement scale as a function of the analytics result, wherein the generated measurement scale is associated with the selected measurement scale.

A third embodiment of the present invention provides a computer system comprising a processor, a memory coupled to said processor, and a computer-readable hardware storage device coupled to said processor, said storage device containing program code configured to be run by said processor via the memory to implement a method for using real-time online analytics to automatically generate an appropriate measurement scale, the method comprising:

the processor identifying a repository of measurement scales;

the processor receiving unstructured data from a user;

the processor performing an analytics procedure upon the unstructured data, wherein the performing produces an analytics result from which may be inferred an intended meaning of the unstructured data;

the processor selecting a selected measurement scale from the repository of measurement scales;

the processor generating a generated measurement scale as a function of the analytics result, wherein the generated measurement scale is associated with the selected measurement scale.

### BRIEF DESCRIPTION OF THE DRAWINGS

FIG. 1 shows the structure of a computer system and computer program code that may be used to implement a method for using real-time online analytics to automatically generate an appropriate measurement scale in accordance with embodiments of the present invention.

FIG. 2 is a flow chart that overviews an embodiment of the method of the present invention.

### DETAILED DESCRIPTION

Embodiments of the present invention employ one or more analytic techniques and models, including techniques and models well-known to those skilled in the arts of text analytics and semantic analytics, to automatically generate measurement scales for surveys, questionnaires, interviews, and other types of interactive, partly interactive, and non-interactive information-gathering instruments.

A researcher or research designer may employ embodiments of the present invention while designing, implementing, or operating an information-gathering instrument. In such contexts, the method of the present invention may automatically select or generate a measurement scale in real time, quickly enough to allow the generated scale to be used by the researcher or research designer during the actual design, implementation, or operation procedure.

Here, real-time generation implies a generation time that may be short enough to accommodate interactive communications between a questioner/researcher and a questioned subject who may be communicating with each other through an application interface, Web browser interface, or other type of computer interface, via spoken communications, or through non-oral text entry. Real-time scale generation may further be fast enough to allow the questioner to consider alternative actions, or otherwise react, interactively in response to the generated measurement scale and to the subject's response to a question.

Embodiments of the present invention may be used during real-time, live or automated interactions between a customer, patient, end-user or other type of subject and a service desk, an other customer-support operation, a health-care provider, a researcher, or an other live or automated questioner. These embodiments may capture unstructured text, unstructured voice, or other types of unstructured or natural-language information as it is received by the questioner from the subject and generate appropriate scales in real time by processing the captured data with techniques well-known to those skilled in the art of analytics. Such unstructured or natural-language received information may comprise combinations of, but is not limited to, the subject's spoken or typed statement, an instant message embedded in a customer relationship management application, parts of a voice-over-IP telephone call conversation, and other types of communications.

The present invention may be embodied as a software application that automates the process of designing or implementing information-gathering instruments like surveys and questionnaires. Such instruments may include, but are not limited to, online surveys, questionnaires, interview scripts, or interactive wizards like those used by service organizations to diagnose or troubleshoot user problems.

Organizing and analyzing the information gathered by such instruments may be facilitated by associating a gathered data element with a measurement scale that may be used for functions that comprise, but are not limited to, normalizing the gathered data element, associating the gathered data element with a qualitative characteristic, such as a descriptive confidence or sentiment factor, or associating the gathered data element with a quantitative characteristic, such as a relative position on the measurement scale.

A measurement scale might, for example, comprise three possible selections: “Very Sure,” “Somewhat Sure,” and “Unsure.” If a subject responds to a questioner's inquiry with the unstructured statement, “I'm not confident that my description is accurate,” the questioner might use the measurement scale to characterize the response as being “unsure.”

Selections of a generated measurement scale may be calibrated in an appropriate unit of measurement, such as inches or minutes, or in unitless quantitative or qualitative ranges that may include, but are not limited to, unitless positive or negative numbers, intensity levels, satisfaction levels, types of sentiment, degrees of desirability, confidence levels, or levels of certainty.

Because there are so many possible types of measurement scales, a well-designed information-gathering instrument may associate a question or a gathered data element with a scale selected specifically for that particular instrument, question, or data element. In some cases, a standard type of measurement scale may be customized for a particular instrument, question, or data element. Such specific selection or customization may be a function of many factors, including, but not limited to, the design, platform, or intent of the research instrument or question, the instrument's or question's context or field of research, characteristics of the information-gathering medium within which the instrument gathers information, the type of statistical analysis expected to be performed upon the gathered data, other characteristics of the subject, the questioner, or the gathered data, and other factors related to the instrument, its contents, its context, its intended purpose or objectives, or its relationship to other information-gathering instruments.

Designing a set of measurement scales appropriate to a set of questions comprised by an information-gathering instrument may be a complex and subtle task that requires the skills and experience of a qualified research designer or service provider. In some cases, the research designer may not be aware of all available measurement options. In some cases, the research designer and the questioner may be distinct entities, and the designer may not be available to select a scale while the subject is responding to a question.

The present invention automates the generation of appropriate measurement scales for online information-gathering instruments, such as interactive surveys, interviews, and questionnaires, by using online text analytics and online semantic analytics to automatically generate appropriate measurement scales in real time. The present invention performs this task by selecting and customizing a set of measurement scales from a larger pool of possible scales, sets of scales, or scale types. Some embodiments of the present invention may perform this automatic selecting and customizing concurrently with online design or implementation activities of a research designer, possibly generating a measurement scale for a question while the research designer enters that question into a computer, or as soon as the research designer completes the entry of that question.

As used in this document, the term “analytics” describes methods, models, or technology well-known to those skilled in the art of statistics, computer programming, analysis, business management science, or operations research, wherein the methods models or technology may be used to reveal meaningful patterns in unstructured data.

Unstructured data in this context describes data or information that is not organized into an identifiable structure. Structured data, on the other hand, is identifiable because it is organized into an identifiable structure, such as a database or a directed graph. Such a structure may comprise a set of data items and a set of relationships among the data items. A relationship and a position or other characteristic of a data item within a data structure may give meaning to the data item or may allow meaning to be inferred. Because unstructured data does not have the benefit of such information-bearing organization, it can be more difficult to infer meaning from a set of unstructured data items.

One example of unstructured data is a natural-language query, which may be phrased in a broad variety of ways understandable to a human listener. Such a query may not be easily analyzed by methods that try to infer meaning by considering the organization of data items organized into a well-defined data structure.

Well-known applications of analytics theory may use statistical or non-statistical methods to perform functions like identifying and describing relationships among variables or data elements, optimizing networks of data elements, or using such relationships to develop components of predictive models.

Analytics may, for example, be used to identify a name or address buried in a block of freeform text, or to identify how to rank a set of items in a particular order, such as chronological order or order of relevance to a particular parameter. Such capabilities may be used, for example, to customize a measurement scale to select a unit of measurement appropriate to the contents of a block of unstructured text, or to organize a set of enumerated ranges into a monotonically increasing or decreasing order.

Text analytics is generally used to solve business problems by analyzing information contained in natural-language or types of other unstructured text. It has been used by those skilled in to art to extract meaning from postings on social-media Web sites, email messages, mobile-device text messages, and freeform-text word-processor documents. Real-time text analytics may be fast enough to perform such functions as text is generated, and online real-term text analytics may perform real-time analysis of freeform or natural-language content as the content is entered into a computer, mobile device, or other computerized platform.

Text analytics software might, for example, use text-mining techniques known to those skilled in the art to identify information-bearing patterns in a block of freeform text or natural-language content by transposing words and phrases, by associating words or phrases with numeric values, by using logical reasoning to draw inferences from word or syllable patterns, or by classifying words or phrases into categories that can be analyzed by rules or knowledgebases to reveal intended meanings. The results of such procedures might then be associated with a data structure, such as a directed graph or a database, allowing the results to be analyzed by data mining procedures known to those skilled in the art of data analysis.

Semantic analytics may use procedures, techniques, and models known to those skilled in the art to attempt to resolve ambiguity between alternate meanings of a word of phrase comprised by natural-language text or by other types of unstructured content. Semantics analytics may comprise some of the procedures and techniques used by text analytics programs, as well as other procedures, techniques, and models known to those skilled in the art.

A semantic-analytics software application might, for example, use techniques and procedures known to those skilled in the art of semantic analysis, to identify the intended meaning of a word “bear” in a freeform user query. In this example, the application might infer that the word “bear” is used as a noun that describes an animal, rather than as a verb that means “to carry.” The application might make this inference by analyzing cues derived from the context of the word within the unstructured query and by referring to rules and data structures that can be used to identify meanings.

Embodiments of the present invention might comprise one or more text analytics and semantic analytics applications that apply these or other known techniques to freeform or natural-language text as it is received from a subject in real time through an online application, such as an interactive troubleshooting wizard, an instant messaging interface, or a speech-recognition application.

Other known applications of text analytics and semantic analytics techniques, procedures, and models may be integrated into or used in conjunction with embodiments of the present invention.

Sentiment analysis, for example, (also known as opinion mining), may be used to infer an attitude of an author of unstructured text, wherein the attitude may comprise an intentional or unintentional emotional subtext or other meaning comprised by the text.

Risk analytics may rank one or more inferred meanings associated with a block of unstructured text in order to compare alternative solutions to a problem or to select one possible inferred meaning over another.

Predictive analytics may be used to identify indicators hidden in a block of unstructured text that may help predict patterns in the block or in another unstructured block of unstructured text, or relationships among components of the block or of another block of unstructured text.

These analytics techniques, procedures, and models are well-known to those skilled in the art and embodiments of the present invention may comprise any of them, or any other types of analytics now or in the future capable of being performed in real-time in an online environment.

Embodiments of the present invention thus allow an unstructured subject response to be structured and analyzed concurrently with or immediately after the response is received, thus allowing a questioner to consider the analysis when characterizing the response and when preparing the questioner's next question. This approach is qualitatively different than one that might analyze and structure collected data after the gathering phase is complete, and then subject the gathered data to a post-facto analysis incapable of providing real-time feedback during the information-gathering procedure.

These and other techniques of text and semantic analytics may be applied to freeform or natural-language content iteratively and in different combinations, with each iteration producing an increasingly refined representation of a subject's response relative to contextual parameters such as relevance, intensity, confidence, or emotional content.

This invention may be implemented as a method performed by a processor of a computer system, as a computer program product, as a computer system, or as a processor-performed process or service for supporting computer infrastructure.

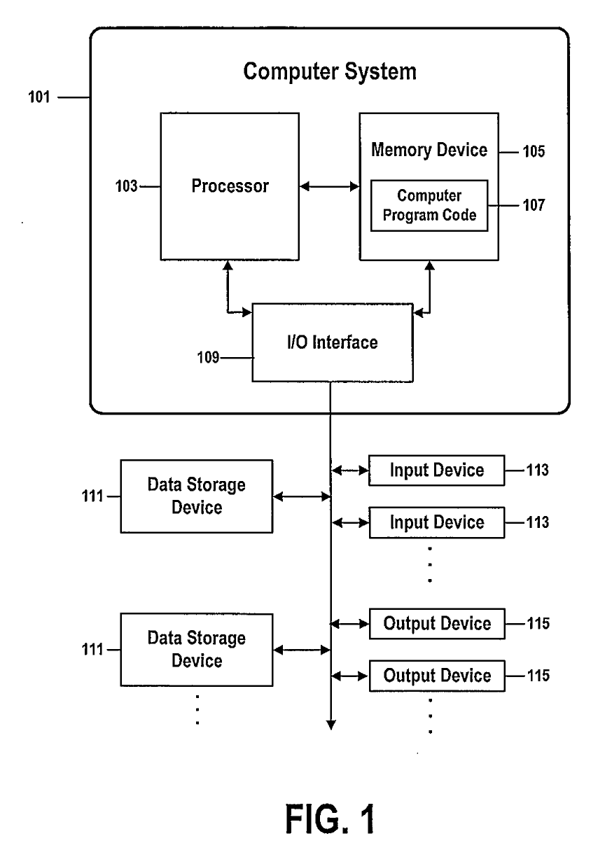

FIG. 1 shows the structure of a computer system and computer program code that may be used to implement a method for using real-time online analytics to automatically generate an appropriate measurement scale in accordance with embodiments of the present invention. FIG. 1 refers to objects 101-115.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, in one embodiment, the present invention may take the form of a computer program product comprising one or more physically tangible (e.g., hardware) computer-readable medium(s) or devices having computer-readable program code stored therein, said program code configured to be executed by a processor of a computer system to implement the methods of the present invention. In one embodiment, the physically tangible computer readable medium(s) and/or device(s) (e.g., hardware media and/or devices) that store said program code, said program code implementing methods of the present invention, do not comprise a signal generally, or a transitory signal in particular.

Any combination of one or more computer-readable medium(s) or devices may be used. The computer-readable medium may be a computer-readable signal medium or a computer-readable storage medium. The computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable storage medium or device may include the following: an electrical connection, a portable computer diskette, a hard disk, a random access memory (RAM), a read-only memory (ROM), an erasable programmable read-only memory (EPROM or flash memory), Radio Frequency Identification tag, a portable compact disc read-only memory (CD-ROM), an optical storage device, a magnetic storage device, or any suitable combination of the foregoing. In the context of this document, a computer-readable storage medium may be any physically tangible medium or hardware device that can contain or store a program for use by or in connection with an instruction execution system, apparatus, or device.

A computer-readable signal medium may include a propagated data signal with computer-readable program code embodied therein, for example, a broadcast radio signal or digital data traveling through an Ethernet cable. Such a propagated signal may take any of a variety of forms, including, but not limited to, electro-magnetic signals, optical pulses, modulation of a carrier signal, or any combination thereof.

Program code embodied on a computer-readable medium may be transmitted using any appropriate medium, including but not limited to wireless communications media, optical fiber cable, electrically conductive cable, radio-frequency or infrared electromagnetic transmission, etc., or any suitable combination of the foregoing.

Computer program code for carrying out operations for aspects of the present invention may be written in any combination of one or more programming languages, including, but not limited to programming languages like Java, Smalltalk, and C++, and one or more scripting languages, including, but not limited to, scripting languages like JavaScript, Perl, and PHP. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN), a wide area network (WAN), an intranet, an extranet, or an enterprise network that may comprise combinations of LANs, WANs, intranets, and extranets, or the connection may be made to an external computer (for example, through the Internet using an Internet Service Provider).

Aspects of the present invention are described above and below with reference to flowchart illustrations and/or block diagrams of methods, apparatus (systems) and computer program products according to embodiments of the present invention. It will be understood that each block of the flowchart illustrations, block diagrams, and combinations of blocks in the flowchart illustrations and/or block diagrams of FIGS. 1-4 can be implemented by computer program instructions. These computer program instructions may be provided to a processor of a general purpose computer, special purpose computer, or other programmable data-processing apparatus to produce a machine, such that the instructions, which execute via the processor of the computer or other programmable data-processing apparatus, create means for implementing the functions/acts specified in the flowchart and/or block diagram block or blocks.

These computer program instructions may also be stored in a computer-readable medium that can direct a computer, other programmable data-processing apparatus, or other devices to function in a particular manner, such that the instructions stored in the computer-readable medium produce an article of manufacture, including instructions that implement the function/act specified in the flowchart and/or block diagram block or blocks.

The computer program instructions may also be loaded onto a computer, other programmable data-processing apparatus, or other devices to cause a series of operational steps to be performed on the computer, other programmable apparatus, or other devices to produce a computer-implemented process such that the instructions that execute on the computer or other programmable apparatus provide processes for implementing the functions/acts specified in the flowchart and/or block diagram block or blocks.

The flowchart illustrations and/or block diagrams FIGS. 1-4 illustrate the architecture, functionality, and operation of possible implementations of systems, methods and computer program products according to various embodiments of the present invention. In this regard, each block in the flowchart or block diagrams may represent a module, segment, or portion of code, wherein the module, segment, or portion of code comprises one or more executable instructions for implementing one or more specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special-purpose hardware-based systems that perform the specified functions or acts, or combinations of special-purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for using real-time online analytics to automatically generate an appropriate measurement scale in accordance with embodiments of the present invention, and may implement other embodiments described in this specification, including the methods illustrated in FIGS. 1-4. The data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method for using real-time online analytics to automatically generate an appropriate measurement scale.

Any of the components of the present invention could be created, integrated, hosted, maintained, deployed, managed, serviced, supported, etc. by a service provider who offers to facilitate a method for using real-time online analytics to automatically generate an appropriate measurement scale. Thus the present invention discloses a process for deploying or integrating computing infrastructure, comprising integrating computer-readable code into the computer system 101, wherein the code in combination with the computer system 101 is capable of performing a method for using real-time online analytics to automatically generate an appropriate measurement scale.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

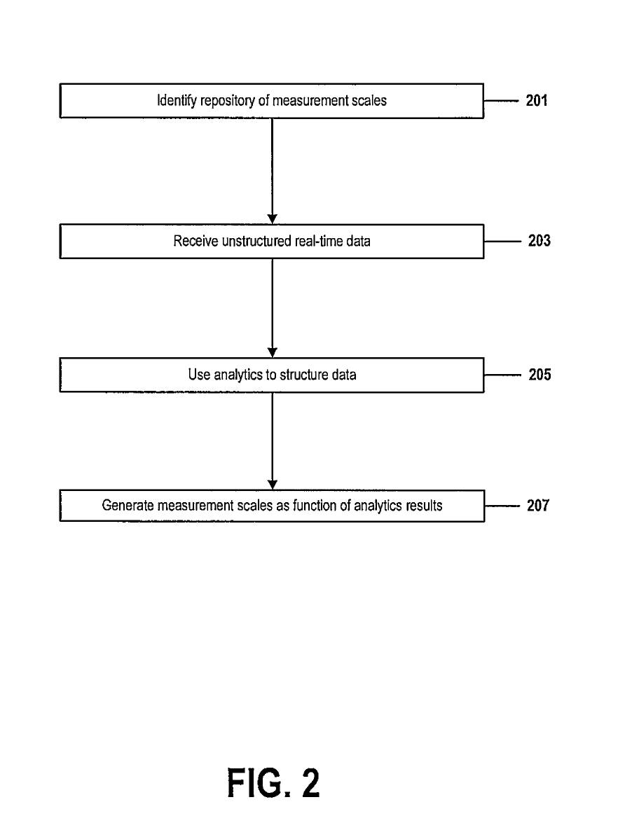

FIG. 2 is a flow chart that overviews an embodiment of the method of the present invention. FIG. 2 comprises steps 201-207.

Step 201 identifies a repository of candidate measurement scales. These scales may be derived from a single source or from a variety of sources. The repository may comprise unpublished scales, scales gathered from published sources (such as scientific or medical journal articles or research papers), and other publicly disclosed scales, such as those referenced in a public presentation.

The repository may be implemented as a single physical entity, such as a listing stored on a hard drive; a single logical entity, such as a distributed database split among multiple sites; or a composite entity that may comprise a set of multiple sources, wherein the sources may be associated with different types of storage media or data formats.

These scales may take any form known to those skilled in the research sciences. A scale may comprise a unit of measurement, a set of value ranges, wherein a range of the set of ranges identifies a quantitative or qualitative subset of all possible values of the unit of measurement, and a set of range identifiers, wherein an identifier of the set of identifiers identifies a range of the set of ranges or a subset of a range of the set of ranges. In some embodiments, a scale may be calibrated in unitless numbers.

Ranges may be purely nominal, or may specify intervals, ratios, or other types of parameters. A set of nominal ranges in a scale, for example, might each designate a classification of a group or category. A scale that comprises a set of interval ranges might comprise five ranges that each span twenty Celsius degrees of a 100-degree span. A ratio range might be associated with a set of height-to-weight ratios. Many other types of units, ranges, identifiers, and scales are known to those skilled in the art.

In an example, if a measurement scale:
1: Very useful 2: Useful 3: Not useful 0: No comment

is deemed to comprise a “usefulness” unit of measurement, the scale would further comprise four value ranges, each of which comprises a single number: {1, 2, 3, 0}. The scale's four range identifiers would each be associated with (and, in this case, would each identify) one value range of the four ranges. The range identifier “Very Useful,” for example, would be associated with a value range of “1.”

This exemplary scale might alternatively be deemed to be a unitless scale, but even in that case, the scale might still comprise the same sets of value ranges and range identifiers and would comprise the same associations between value ranges and range identifiers.

In other embodiments, measurement scales may assume any of a variety of more general forms. In some cases, the repository may comprise building blocks of scales, such as sets of identifiers or sets of value ranges that are not associated with a single unit of measurement, wherein a subset of the building blocks may be used to assemble a measurement scale.

In step 203, unstructured data is received from a research designer or a subject. Data received from a subject may be a real-time response to a question of an information-gathering instrument and data received from a research designer may be a draft version of a question intended to be incorporated into an information-gathering instrument.

As described above, this unstructured data may be in the form of a natural-language query or statement, or may take the form of other types of freeform or unstructured text. In this embodiment, the data entry takes place interactively and in real time through an online mechanism, such as a user manually entering data on a computer keyboard or mobile device, wherein the keyboard or mobile device may be connected to the Internet, to a local computer, to a cellular network, to a wireless data network, or to an other type of communications infrastructure. In other embodiments, the data entry may be performed through other means, such as submitting a text file or a database file to an application program.

Step 205 processes the data entered in step 203 through text analytics or semantic analytics programs, wherein the programs analyze the data by means of analytics procedures, techniques, or models known to those skilled in the relevant arts. These procedures, techniques, or models may generate a result that identifies and associates a meaning or intent with the unstructured entered data and further associates the meaning or the entered data with one or more scales comprised by the repository. The form and structure of the result is implementation-dependent and may be known to those skilled in the art as a function of the analytics procedures, techniques, or models.

Step 207 selects one or more scales comprised by the repository as a function of the result generated in step 205. In some embodiments, step 207 identifies those scales to the user who entered the real-time unstructured data in step 203. In other embodiments, step 207 returns the scales in response to submission of unstructured data that was submitted through other means in step 201.

In some embodiments, the selected scales are further customized as a function of the result generated in step 205 (or as a function of other criteria), in order to make the scales more appropriate to the intended meaning of the user's unstructured input.

In some embodiments the customized scales are stored in the repository, where they may become available during future iterations of an embodiment of the method of the present invention.

In an example of how an embodiment of the present invention might work, consider a service organization's effort to analyze the usability of a user-operated diagnostic program by creating a user-feedback questionnaire.

In this example, a survey designer might create the questionnaire by entering each question into a survey-generation application that comprises the embodiment of the present invention. This embodiment might include a repository of measurement scales, wherein each scale is associated with identifiers that relate it to other stored data. In some embodiments, the other stored data might comprise data structures that store representations of text items. In other embodiments, the other stored data might comprise data structures that store representations of and relationships between semantic meanings of text, data, or other elements of natural-language strings. In either case, these data structures, storage methods, technologies, and procedures are well-known to those skilled in the art of text analytics or semantic analytics. In some embodiments, these data structures and stored information might be stored at a remote site or on the Internet.

In the current example, the survey designer might begin designing the survey by entering a question:

“How useful was the diagnostic program in solving your problem?”

The application might then use known techniques, procedures, and models of text analytics to analyze the natural-language question, translate the question into structured data, use information culled from the structured data to select appropriate scales from the repository, and to customize those selected scales into a set of candidate scales appropriate for the entered question. This selection and customization would be done in real-time, either simultaneously with or concurrently with the designer's typing.

In this example, the application might select and customize three candidate scales as a function of the words and phrases comprised by the designer's question. As described above, this selection and customization might use techniques of text analytics and semantic analytics to identify “usefulness” as a parameter to be measured and to identify the designer's natural-language question as an attempt to quantify degree of usefulness.

The three candidate measurement scales might thus comprise the scales:
5: Very useful 4: Useful 3: A little useful 1: Not useful
1: Very useful 2: Useful 3: Not useful 0: No comment
2: Useful 1: Not useful 0: Don't know

In some embodiments, these three candidate scales might be displayed to the designer, who would select the one candidate scale that she deems to be most appropriate. In other embodiments, only the single scale deemed most appropriate by the application is displayed to the designer.

In another embodiment of the present invention, consider a Customer Service operation tasked with measuring customer reaction to a service outage. Here, a service-desk team member calls affected customers to read scripted questions designed to measure each customer's reaction to the outage. Speech-recognition software monitors each call, capturing customer natural-language responses as unstructured text and then forwarding the captured text to a scale-generating program that conforms to the method of the present invention.

The program uses known techniques, procedures, and models of text analytics and semantic analytics to infer intended meaning of a captured, unstructured customer response to a question. The program then selects a set of appropriate measurement-scale templates from a database of scale templates and tailors those templates to better fit the context of the survey effort and of the question.

Here, the selection and the tailoring are functions of the analytics results and the context of the survey effort may be a function of the goals of the survey, the contents and structure of the script, an exact wording, sentiment, or other characteristic of a customer's answer to a particular question, an exact wording, sentiment, or other characteristic of the customer's overall responses to multiple questions, a characteristic of the speech-recognition software, an exact wording, sentiment, or other characteristic of an other customer's response to a particular question or to multiple questions, or other implementation-dependent factors.

Once the program has selected and customized a scale or scales in response to a customer's response to a scripted question read by a service-desk team member, the program may then forward the selected, customized scale or scales to the team member quickly enough to allow the service-desk team member to use the scale or scales to immediately characterize the prior response or to affect a characteristic of the remainder of the questioning procedure. Here, this quick response time would be considered “real-time” response.

The team member might then, depending on details of the survey implementation, use the scale or scales to generate a new question on-the-fly or to subjectively characterize the customer's response to the scripted question.

In another example, a business uses a computer-system embodiment of the method of the present invention to develop a Business Impact Analysis survey intended to gather information about the effect of several possible disaster scenarios upon business operations. When completed, the survey under development will comprise unstructured text descriptions of several scenarios, each followed by questions about the effect of the scenario on a business operation.

The computer system's semantic and text analytics engine uses the method of the present invention to identify the meaning and context of a scenario description as it is interactively entered by the survey developer. The computer system then uses this understanding to further interpret the purpose of a follow-up question, as the question is entered, and to quickly generate a set of appropriate customized scales that the user may integrate into the survey.

In yet another embodiment, a consumer-goods business uses the method of the present invention to tailor interactions between its customers and its customer-service representatives as a function of information comprised by social media chatter about the business and the business's products. Here, a software embodiment of the present invention monitors customer chat data on social media and social networks, using known procedures, techniques, and models of text analytics and semantic analytics to identify references to the business or its products in the unstructured chatter. The software embodiment then uses meanings inferred from the identified data to select a set of measurement scales from a database of common measurement scales and to customize the selected scales for interaction with customers about a specific product or product line. A service representative may then use those scales to as a guideline for quantizing and characterizing the representative's unstructured interactions with a customer.

In a variation of this embodiment, the software might supplement an information-gathering effort currently underway between a service representative and a particular customer by seeking out unstructured comments previously posted by that customer on a social-media Web site or transmitted over a social network service. The software might than use its analysis of these unstructured comments to generate customized measurement scales that it forwards to the representative while the representative is still interacting with the customer.

In yet another embodiment, a nurse-practitioner interviews a patient by reading a prepared script from a handheld tablet device. The tablet runs an embodying application that uses speech-recognition software to monitor the patient's unstructured response to a question, uses a set of analytics programs to analyze the unstructured response, and then selects several measurement scales from a database of scales stored on the tablet, wherein the selecting is a function of the analysis of the patient response.

The application customizes the several scales as a further function of the analysis of the patient response. It then displays the customized scales on the tablet, allowing the nurse-practitioner to choose a scale that allows him to most appropriately characterize the patient's response. This characterization may comprise selecting a value range or range identifier comprised by the chosen scale. In some embodiments, when the embodying application displays the measurement scales, it may further display comments or instructions that help the nurse-practitioner choose the most appropriate scale. In other embodiments, the application may select a single scale that it deems most appropriate, based on its understanding of the intended meaning of the question, the response, and the intent of the interview.

At the conclusion of the interview, other software and network modules may generate a report, chart, or graph as a function of the nurse-practitioner's measurement-scale selection for each interview question. In some embodiments, other software and network modules may perform other types of qualitative, quantitative, or statistical analyses of the patient's responses, as analyzed by the application, as characterized by the nurse-practitioner's measurement-scale characterizations, or as characterized by aggregated data and characterizations gathered from multiple interviews by one or more related healthcare professionals.

What is claimed is:

1. A method for using real-time online analytics to automatically generate an appropriate measurement scale, the method comprising:
a processor of a computer system identifying a repository of measurement scales;
the processor receiving unstructured data from a user;
the processor performing an analytics procedure upon the unstructured data, wherein the performing produces an analytics result from which may be inferred an intended meaning of the unstructured data;
the processor selecting a selected measurement scale from the repository of measurement scales;
the processor generating a generated measurement scale as a function of the analytics result, wherein the generated measurement scale is associated with the selected measurement scale.

2. The method of claim 1, wherein the unstructured data is selected from a group comprising a solicitation of information and a response to a solicitation of information.

3. The method of claim 1, wherein the performing, the selecting, and the generating occur in real time.

4. The method of claim 3, further comprising the processor communicating the generated measurement scale to the user, wherein the communicating occurs in real time.

5. The method of claim 1, wherein a measurement scale of the repository of measurement scales identifies a set of values and a set of value identifiers, and wherein a first value identifier of the set of value identifiers is associated with a first value of the set of values.

6. The method of claim 1, wherein the analytics procedure is selected from a group comprising an online text analytics procedure and an online semantic analytics procedure.

7. The method of claim 1, wherein the repository of measurement scales comprises a first measurement scale that has been publicly disclosed.

8. A computer program product, comprising a computer-readable hardware storage device having a computer-readable program code stored therein, said program code configured to be executed by a processor of a computer system to implement a method for using real-time online analytics to automatically generate an appropriate measurement scale, the method comprising:
the processor identifying a repository of measurement scales;
the processor receiving unstructured data from a user;
the processor performing an analytics procedure upon the unstructured data, wherein the performing produces an analytics result from which may be inferred an intended meaning of the unstructured data;
the processor selecting a selected measurement scale from the repository of measurement scales;
the processor generating a generated measurement scale as a function of the analytics result, wherein the generated measurement scale is associated with the selected measurement scale.

9. The method of claim 8, wherein the unstructured data is selected from a group comprising a solicitation of information and a response to a solicitation of information.

10. The method of claim 8, wherein the performing, the selecting, and the generating occur in real time.

11. The method of claim 10, further comprising the processor communicating the generated measurement scale to the user, wherein the communicating occurs in real time.

12. The method of claim 8, wherein a measurement scale of the repository of measurement scales identifies a set of values and a set of value identifiers, and wherein a first value identifier of the set of value identifiers is associated with a first value of the set of values.

13. The method of claim 8, wherein the analytics procedure is selected from a group comprising an online text analytics procedure and an online semantic analytics procedure.

14. The method of claim 8, wherein the repository of measurement scales comprises a first measurement scale that has been publicly disclosed.

15. A computer system comprising a processor, a memory coupled to said processor, and a computer-readable hardware storage device coupled to said processor, said storage device containing program code configured to be run by said processor via the memory to implement a method for using real-time online analytics to automatically generate an appropriate measurement scale, the method comprising:
the processor identifying a repository of measurement scales;
the processor receiving unstructured data from a user;
the processor performing an analytics procedure upon the unstructured data, wherein the performing produces an analytics result from which may be inferred an intended meaning of the unstructured data;
the processor selecting a selected measurement scale from the repository of measurement scales;
the processor generating a generated measurement scale as a function of the analytics result, wherein the generated measurement scale is associated with the selected measurement scale.

16. The method of claim 15, wherein the unstructured data is selected from a group comprising a solicitation of information and a response to a solicitation of information.

17. The method of claim 15, wherein the performing, the selecting, and the generating occur in real time.

18. The method of claim 17, further comprising the processor communicating the generated measurement scale to the user, wherein the communicating occurs in real time.

19. The method of claim 15, wherein a measurement scale of the repository of measurement scales identifies a set of values and a set of value identifiers, and wherein a first value identifier of the set of value identifiers is associated with a first value of the set of values.

20. The method of claim 15, wherein the analytics procedure is selected from a group comprising an online text analytics procedure and an online semantic analytics procedure.
